(19) United States
(12) Patent Application Publication
(10) Pub. No.: US 2006/0251477 A1
(43) Pub. Date: Nov. 9, 2006

(54) Contained oil production facility

(76) Inventor: Gordon R. Brower, Barrow, AK (US)

Correspondence Address: LITMAN LAW OFFICES, LTD, PO BOX 15035, CRYSTAL CITY STATION, ARLINGTON, VA, 22215, US

(21) Appl. No.: 11/186,779

(22) Filed: Jul. 22, 2005

Related U.S. Application Data
(60) Provisional application No. 60/676,953, filed on May 3, 2005.

(51) Int. Cl. E02B 15/00; C02F 1/28; B01D 15/04

(52) U.S. Cl. 405/63; 210/923; 405/60

(57) ABSTRACT

A crude oil production facility is constructed to prevent oil spills emanating from the production field wellheads from entering and despoiling the adjacent natural environment. This is achieved by installing a continuous, closed wall such as a cylindrical tank around the field of producing wellheads so that the oil spill cannot pass under or through the continuous wall. The continuous, closed wall is particularly effective for offshore installations wherein the facility resides on an artificial, or natural island including conventional drilling and production platforms as an option. The collected spilled oil is transferred to the shore installation through the subsea pipeline typically used to transport produced oil from the well head field to the shore storage facility. The subsea pipeline preferably consists of pipes within a pipe construction.

### CROSS-REFERENCE TO RELATED APPLICATION

This application claims the benefit of U.S. Provisional Patent Application Ser. No. 60/676,953, filed May 3, 2005.

### BACKGROUND OF THE INVENTION

1. Field of the Invention The invention relates to an integrated crude oil production facility embodying a process for the continual protection of the environment from accidental crude oil spillage occurring in an offshore oil production field. The process principally includes the installation of a tank or other barrier means surrounding the producing oil field well heads to collect any spilled crude oil while using the in-place field-to-shore pipelines to pump the spilled oil to the shore-based crude oil collection installations.

2. Description of the Related Art

The world's industrial nations are continually challenged by the dilemma of how to meet the huge energy needs of industrialized societies, without seriously or irreversibly corrupting the natural environment. Much of the focus of that dilemma falls onto the production, transportation and utilization of crude petroleum oil, which accounts for a major share of the energy produced. As readily available oil reserves in North America dwindle, petroleum companies look to maintain adequate reserves-to-demand ratio by exploring and producing from ever more challenging locations harboring ever more fragile environments. Two of such locations were the Gulf of Mexico and the Alaska North slope developments, where the threat of despoliation via oil spills was tested and successfully managed.

Now Alaska is entering a new phase of petroleum exploration and production in pristine locations with environmental protection from oil spillage holding a top priority. The search continues for better technology to protect the environment from oil spills as well as to lower the escalating cost of providing that protection Fleets of barges and numerous personnel are now regularly maintained near oil fields to quickly respond to the inevitable oil leaks or more serious oil spills. The cost for such protection is high. New ways to overcome the oil leak and spill problem are needed.

One offshore oil well leakage confiner is known as follows. The confiner comprises a circular wall surrounding the wellhead and anchored to the seabed. The wall is composed of welded plates with pontoons attached to the exterior of the wall such that the circular wall can be raised or lowered around the wellhead by inflating or deflating the pontoons. Any oil that has leaked can be maintained on the water surface within the confiner and collected while the confiner can be raised to accommodate the amount of spilled oil. A raft is connected to the exterior of the confiner with control means attached to operate the pontoons when required to adjust the height of the wall above the water surface. Accumulated oil spill is removed from the confiner by transfer to a ship or barge. However, raising and lowering a large container to collect spilled oil over an oil field is impracticable.

Another known structure is a protective containment device surrounding an offshore drilling platform. The protective device comprises a curtain attached to a suitable support structure. The curtain can be raised or lowered by flotation as needed to enclose the platform and contain any oil spillage. When lowered the curtain rests on the seabed.

The prior art contains other structures to contain spilled crude oil from drilling and production platforms, usually incorporating flotation to operate the confining apparatus. However, the prior art structures are generally costly and require frequent servicing to maintain operability. They also require tankers or barges to carry off the collected spilled oil. Thus a contained oil production facility solving the aforementioned problems is desired.

### SUMMARY OF THE INVENTION

The invention comprises the method and the facility for removing crude oil spills in a field of crude oil producing well heads by installing a continuous, closed wall around the well head field. The invention provides a method for capturing and containing the spilled oil so that any spilled oil is contained within the field. The contained spilled oil is removed to a storage facility using the existing piping in the field that is available for product oil transportation. The method and facility of the invention are particularly useful when applied in conjunction with offshore oil production platforms, where the closed wall is installed on an offshore man-made artificial island containing the producing wellheads.

The contained oil production facility of the invention comprises a tank or wall or similar barrier capable of accommodating and containing the spills from large-scale oil production on an artificial island or on land. Preferably, the oil wells are fabricated inside the tank for the production of crude oil. The tank is constructed on a man-made artificial island or land, which is connected to the shore through a sub sea pipeline. The tank and similar containment means are preferably of modular or sectional construction and can be assembled or disassembled in transportable sections for use in multiple working oil fields. The oil wells are drilled within the tank housing the producing well heads within the tank. During production, if any one of the well heads is spilling uncontrolled crude into the tank confinement, all spilled oil is pumped down the sub sea pipeline; thus, providing protection for the natural environment from any oil spillage that may occur within the tank. As employed herein, the term sub sea pipelines refers to pipelines which may be buried in the ocean floor or installed to lie upon the ocean floor.

In a preferred embodiment of the invention, the sub sea pipeline component of the instant invention is configured as a pipe within a pipe so that the outer pipe serves as the housing and containment structure for potential spilled fluids from the inner multi-phase pipelines which serve as a containment barrier of the sub sea pipelines, i.e., pipelines within pipelines. Typically, the inner multi-phase pipelines comprise a bundle of three separate pipelines that transport crude oil, natural gas and water to the shore storage facility. Leak detection is through the loss of pressure of one of any pipe within the main pipe housing or the metering of fluids coming in the pipe and exiting any one of the inner pipes. Any loss of crude oil from any inner pipe will be captured and contained in the outer pipe, and be recovered from the shore facility for proper disposal. The sub sea pipeline serves both to pass product oil from the well head to a shore product gathering installation and alternatively serves as a means to carry off spilled oil to the shore product gathering installation. Through this arrangement the management of an oil spill is transferred from an offshore operation to an onshore operation. This is a great benefit to all involved in oil spill clean up, particularly during the winter and the broken ice winter conditions of the Arctic Ocean where a winter clean up of uncontained spilled crude oil is a very expensive and dangerous task. This is also beneficial to the marine mammals in the Arctic, some of which are protected endangered species such as Polar Bears and Bowhead Whales. By employing the facility and process of the invention no spilled or leaked oil enters the natural environment.

Some of the advantages of the facility and method of the instant invention include: reduction or elimination of the possibility of a large scale crude oil spill damaging the environment; ready recovery of the product oil from an oil spill via the sub sea pipeline; operation of the containment facility from the shore installation; elimination of the need to maintain a large offshore barge response system for oil spills large and small, particularly in the inhospitable environs; and a substantial reduction in the cost of producing crude oil, especially in the Artic regions.

These and other features of the present invention will become readily apparent upon further review of the following specification and drawings.

### BRIEF DESCRIPTION OF THE DRAWINGS

FIG. 1 is an environmental elevation view of a contained oil production facility according to the present invention.

FIG. 2 is a cross sectional view of the container well head facility of FIG. 1.

FIG. 3 is an internal view of the sub sea containment pipeline and multi-phased system of pipes within the containment pipe.

FIG. 4 is an additional environmental view of the tank production design with a buried sub sea line.

Similar reference characters denote corresponding features consistently throughout the attached drawings.

### DETAILED DESCRIPTION OF THE PREFERRED EMBODIMENTS

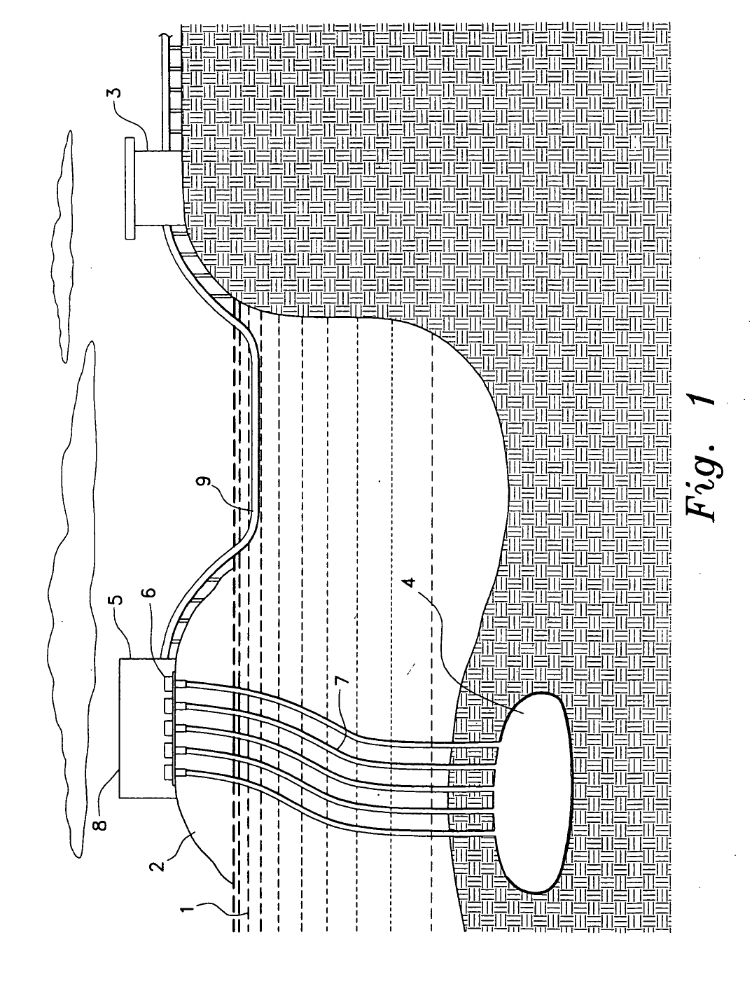

Referring to FIG. 1, the integrated facility of the invention is depicted that allows the ready capture of an oil spill or oil leak by the stationery container or barrier that encompasses all or a large portion of the well head field. The stationery container or barrier is a fixed installation of continuous walls that seal the wellhead facility from the adjacent exterior environs. The available piping in the wellhead field, which normally transports product crude oil to a shore based collection station or, optionally, to an oil tanker, can now be integrated into the spillage recovery operation. The pipe system can pump and transport the recovered oil spill to the collection station on shore that normally is used to collect and export the wellhead oil. In the integrated facility as depicted in FIG. 1, the stationary container or tank 5 is installed as a large cylindrical wall with the top open to the atmosphere. It is installed on an artificial island 2 that contains the active wellheads 6 and an optional hatch structure 8 for servicing the pumps and other equipment. The container or tank surrounds the wellhead emplacements. The wellheads are connected to the oil field 4 in the ground through well pipes 7. Oil from the wellhead installation or collected spilled oil is passed to the shore collection station 3 through sub sea pipes 9 in the ocean 1.

FIG. 1 illustrates one overall key advantage of the instant invention over the offshore spilled oil recovery operations of the prior art. That advantage is the immediate use of onsite operating systems at the offshore location to collect the spilled oil and transport the oil spill to the regular shore based collection facility for treatment or disposal.

The sub sea pipelines already in place and connecting the well head field with the shore collection station serve well to meet that end and serve to shift the control of the oil spill problem from a manual offshore operation to an optional automated onshore operation.

The advantage just described holds great promise for major cost reductions in managing the recovery and cleanup associated with crude oil spills in producing fields. However, although in-place facilities can be used in the instant invention to pipeline spilled oil to shore, nothing within the context of the invention prohibits the disposal of the oil spill by transferring the collected spilled oil to ships and barges for transport to another destination instead of a nearby shore collection facility.

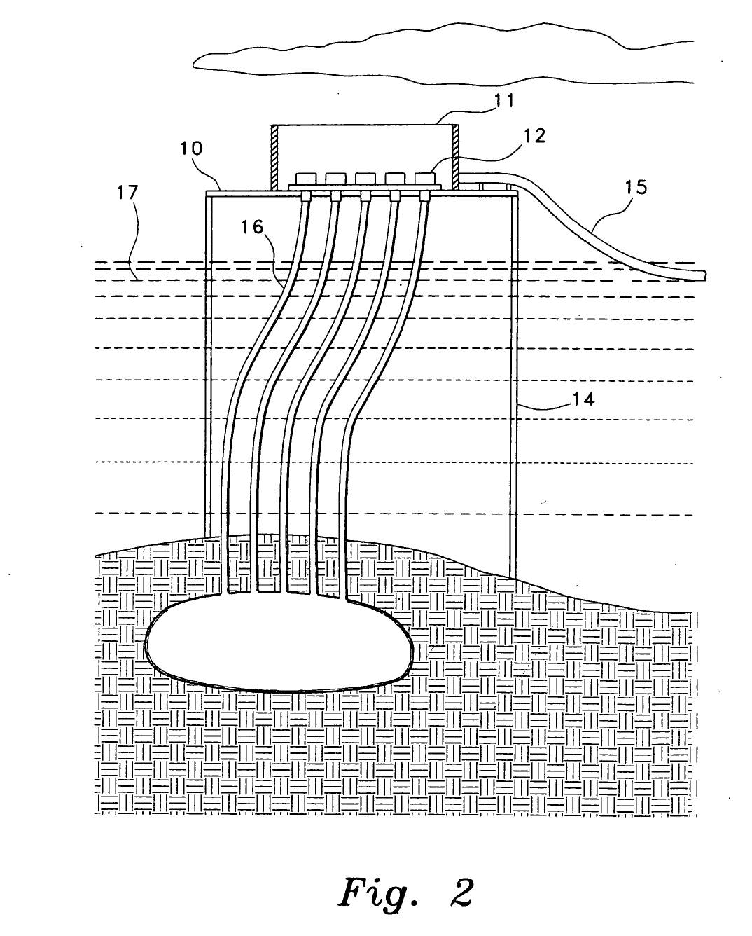

Referring to FIG. 2, a cross sectional view of the wellhead facility is presented. The tank 11 preferably is open at the top, surrounding and enclosing the wellheads such that any oil that may leak from the wellheads cannot pass through or under the tank wall. The tank construction material may consist of any material that is impervious to oil and water. Preferably, the material of construction is a metal such as steel, fabricated into plates, but suitable tanks can be prepared from concrete, cinder block, common brick, wood and structural plastics such as fiberglass-reinforced plastics. As used herein, the term “tank” is not intended to be limited to only the common concept of a tank as being solely a cylindrical vessel. Instead, the shape of the tank as used herein may take that of any geometric configuration that can form a continuously closed wall or barrier having an open top including cylindrical, rectangular, triangular, square or serpentine. For the purposes of this invention the term “tank” is equivalent to the words “container”, “wall”, “barrier” “dam”, “dike” and the like.

One or more tanks are installed or constructed on an artificial island such as a commonplace drilling platform 10 that contains the oil production well heads 12. These platforms are typically supported by steel columns or legs 14, through the ocean 17, resting on the ocean bottom. The island may also be a natural earth island, a man-made island over the oil field, or an oil exploration and producing vessel firmly anchored to the sea bottom. All of these island-types can contain producing wellheads well above the surrounding ocean high water mark but still with the continuing risk of an oil spill within the containment area. Each island may contain numerous wellheads and producing wells 12 connected through the production pipeline 16 to the crude oil field. The pipeline 15 transports the product of the wellheads 12 to the shore collection station. When a spill does occur, the same pipeline 15 transports the oil spill to a shore-based storage facility.

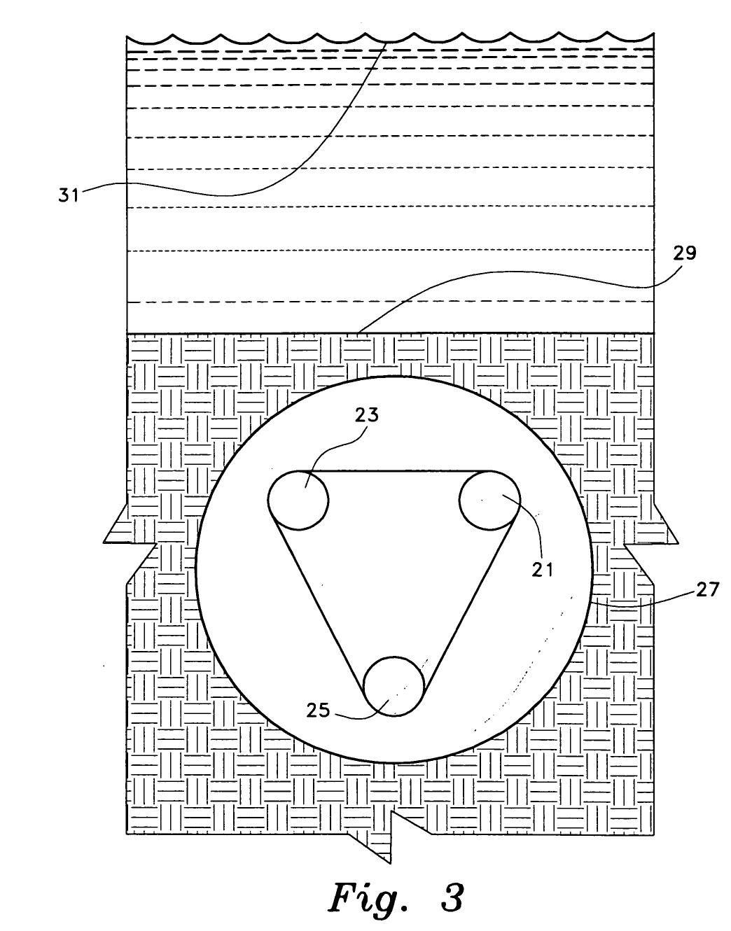

Referring to FIG. 3, the pipes within pipe configuration of the invention for transporting petroleum products or spilled oil is illustrated. The inner bundle of pipes 21,23,25 are for transportation of crude oil 21, natural gas 23 and water 25, respectively. The outer containment pipe assures the containment of any leaks as well as the transportation of surface oil spills. The pipe within a pipe is buried under the sea bed 29 protected from icebergs or other ice flows in the ocean.

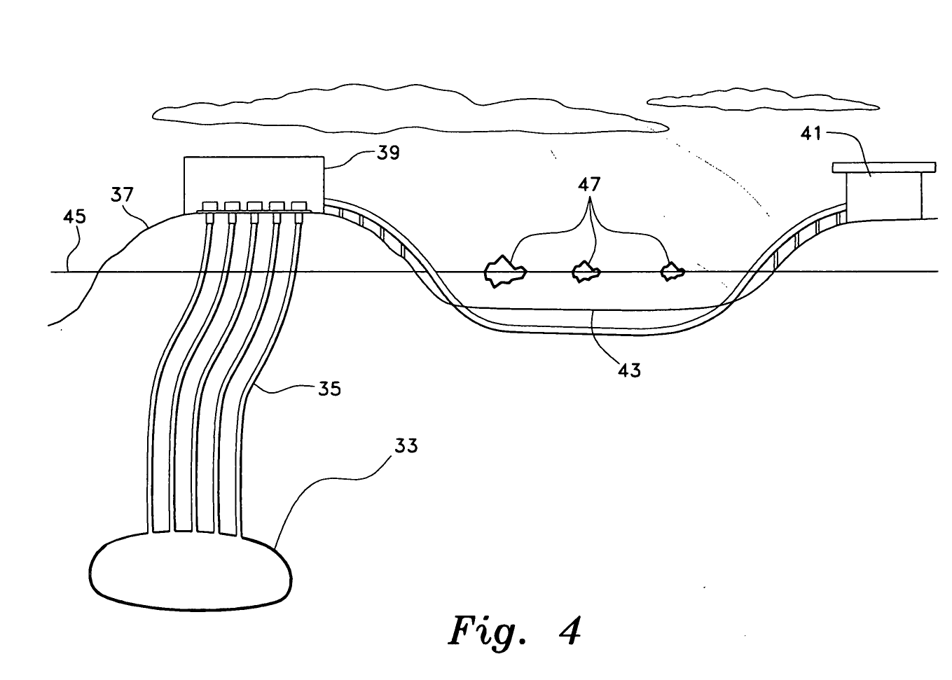

Referring to FIG. 4, the total installation of the oil field 33, is illustrated including oil field 33, pipelines 35, the artificial island 37, the containment tank 39, product storage 41, pipe lines buried sub sea to product storage 41, the ocean 45, with icebergs 47.

It is to be understood that the present invention is not limited to the embodiments described above, but encompasses any and all embodiments within the scope of the following claims.

I claim:

1. A method for capturing, containing and removing spilled crude oil in a field of crude oil producing well heads comprising:
installing a continuous, closed wall around the well head field such that any spilled oil is contained within said field; and
transporting the contained spilled oil to a storage facility using the piping in the field available for product oil transportation.

2. The method of claim 1, wherein the closed wall is installed on an offshore, man-made artificial island containing the producing wellheads.

3. The method of claim 1, wherein the closed wall comprises a dike.

4. The method of claim 1, wherein the man-made artificial island comprises an exploration and/or oil-producing platform.

5. The method of claim 1, wherein the artificial island comprises a natural island.

6. The method of claim 1, wherein the spilled oil is removed by ship.

7. A facility for capturing and containing spilled crude oil in an offshore field of crude oil well head production pumps comprising:
an artificial island containing said well head pumps;
a continuous closed wall around said pumps; and
means for pumping and transporting the contained spilled crude oil to a storage facility.

8. The facility of claim 7 wherein said continuous closed wall comprises a cylindrical open top tank.

9. The facility of claim 7 wherein said tank is of modular construction.

10. The facility of claim 7, wherein said continuous closed wall comprises a dike.

11. The facility of claim 7, wherein said artificial island comprises a crude oil exploration or production platform.

12. The facility of claim 7, wherein the storage facility is contained within said wall.

13. The facility of claim 7, wherein the shape of said continuous closed wall comprises any geometric configuration that can form a continuously closed wall having an open top, including but not limited to, cylindrical, rectangular, triangular, square and serpentine shapes.

14. The facility of claim 7 where the piping in the field available for product oil transportation comprises a bundle of pipes within a pipe.

15. The facility of claim 7 wherein where the piping in the field available for product oil transportation comprises a bundle of three pipes within a pipe for natural gas, crude oil and water transportation.

16. The facility of claim 7 wherein said transportation pipes are subsea buried pipes.
